(19) United States
(12) Patent Application Publication
(10) Pub. No.: US 2017/0132553 A1
(43) Pub. Date: May 11, 2017

(54) SYSTEM AND METHOD FOR COMPUTATIONAL ANALYSIS OF THE POTENTIAL RELEVANCE OF DIGITAL DATA ITEMS TO KEY PERFORMANCE INDICATORS

(71) Applicant: RUBIKLOUD TECHNOLOGIES INC., Toronto (CA)

(72) Inventors: Dan THEIRL, Toronto (CA); Kerry LIU, Toronto (CA); Brian KENG, Toronto (CA); Waleed AYOUB, Toronto (CA); Neil LAING, Toronto (CA)

(21) Appl. No.: 15/295,473

(22) Filed: Oct. 17, 2016

Related U.S. Application Data
(60) Provisional application No. 62/242,998, filed on Oct. 17, 2015.

(51) Int. Cl. G06Q 10/06; G06F 17/30

(52) U.S. Cl. CPC G06Q 10/06393; G06F 17/30327

(57) ABSTRACT

Systems and methods are presented for the computational analysis of the potential relevance of digital data items to key performance indicators. A server system imports bulk amounts of digital data from one or more disparate network-accessible digital data sources. The server system comprises an insight module configured to implement a tree-structure analysis method to identify those events in the digital data most likely to impact selected performance indicators for a given business. The results of the tree-structure analysis method are presented to the business via a user interface displayed on a computing device operated by the business. The most relevant events are presented in a distinctive manner. A recommendation module may be provided to generate recommendations from the insights.

### TECHNICAL FIELD

The following relates generally to automated analysis of digital data and more specifically to the computational analysis of the potential relevance of digital data items to key performance indicators.

### BACKGROUND

There is currently an abundance of technologies that monitor, track, gather, assemble, obtain and leverage digital data from disparate sources. The digital data may relate, for example, to customer interactions with businesses, businesses' performance, and other types of digital data potentially relevant to businesses' performance. Given the vast amounts of electronic data available for analysis, identification of the most relevant data for any particular analysis may pose challenges.

### SUMMARY

In one aspect, there is provided a system for generating and analyzing a tree-graph representation of a plurality of digital data items for computational analysis of the potential relevance of the digital data items to key performance indicators (KPIs) to unveil each of the digital data items that are statistically relevant to the KPIs, the digital data items originating from at least one digital data source, the system including: a digital data database for storing at least the digital data; and a data analysis server linked to the digital data database, the data analysis server in communication with the at least one digital data source, the data analysis server including one or more processors configured to execute, or direct to be executed: an import module for receiving the digital data items from the at least one digital data source; and an insight module for tree-graph analysis of the digital data items received by the import module, the tree-graph analysis including: receiving one or more KPIs; representing each of the one or more KPIs by a seed node; recursively identifying child nodes emanating from each of the one or more seed nodes until there are no statistically significant child nodes, and linking each child node to its parent node from which the child node emanates, each of the child nodes representing one of the digital data items; analyzing each of the child nodes, alone or in combination with one or more other child nodes, to determine an anomalous event, the anomalous event comprising a deviation which is greater than a threshold amount; and determining the impact of each of the child nodes associated with one of the anomalous events on its associated parent node.

In another case, machine learning techniques are utilized to determine the impact of the anomalous events.

In yet another case, the child nodes are determined by segmentation of the associated parent node.

In yet another case, the segmentation is based on periods of activity.

In yet another case, machine learning techniques are utilized to determine the segmentation.

In yet another case, analyzing each of the child nodes further includes not analyzing a particular one of the child nodes if that particular child node is shared with another parent node and has already been analyzed.

In yet another case, the one or more processors of the data analysis server are further configured to execute, or direct to be executed, a recommendation module for predicting the impact of events on a predetermined objective based on historical digital data and the statistically significant events.

In a further case, the recommendation module uses a four quadrant approach to analyze correlated changes in the digital data to optimize an output for the predetermined objective.

In yet a further case, the optimization of the output for the predetermined objective uses machine learning techniques.

In yet another case, the system further includes a portal linked to a user interface on a computing device for receiving the one or more KPIs from a user and communicating the one or more KPIs to the insight module of the data analysis server.

In yet another case, the threshold amount is dynamic and chosen by the insight module using machine learning techniques.

In another aspect, there is provided a method for generating and analyzing a tree-graph representation of a plurality of digital data items for computational analysis of the potential relevance of the digital data items to key performance indicators (KPIs) to unveil each of the digital data items that are statistically relevant to the KPIs, the method includes: receiving, via an import module executed on one or more processors, the digital data items; receiving, via the insight module executed on one or more processors, one or more key performance indicators (KPIs); representing, via the insight module executed on one or more processors, each of the one or more KPIs by a seed node; identifying, recursively, via the insight module executed on one or more processors, child nodes emanating from each of the one or more seed nodes until there are no statistically significant child nodes, each of the child nodes representing one of the digital data items; linking, via the insight module executed on one or more processors, each child node to its parent node from which the child node emanates; analyzing each of the child nodes, alone or in combination with one or more other child nodes, to determine an anomalous event, the anomalous event comprising a deviation which is greater than a threshold amount; and determining the impact of each of the child nodes associated with one of the anomalous events on its associated parent node.

In another case, machine learning techniques are utilized to determine the impact of the anomalous events.

In yet another case, clustering techniques are utilized to determine the impact of the anomalous events.

In yet another case, analyzing each of the child nodes further includes not analyzing a particular one of the child nodes if that particular child node is shared with another parent node and has already been analyzed.

In yet another case, the method further includes predicting, via a recommendation module executed on one or more processors, the impact of events on a predetermined objective based on historical digital data and the statistically significant events.

In a further case, the predicting of the impact of events uses a four quadrant approach to analyze correlated changes in the digital data to optimize an output for the predetermined objective.

In yet another case, the one or more seed nodes are dynamically identified based on high-level performance metrics of the digital data.

In yet another case, the threshold amount is dynamic and chosen by the insight module using machine learning techniques.

In yet another case, the threshold amount is five-percent (5%).

These and other aspects are contemplated and described herein. It will be appreciated that the foregoing summary sets out representative aspects of systems and methods to assist skilled readers in understanding the following detailed description.

### DESCRIPTION OF THE DRAWINGS

A greater understanding of the embodiments will be had with reference to the Figures, in which:

FIG. 1 illustrates a block diagram of a computer-implemented system for insightful analysis of digital data from disparate sources;

FIG. 2 illustrates a method for analyzing digital data to generate insights for a business;

FIG. 3 illustrates an embodiment of a user interface to present insights to a business;

FIG. 4 illustrates another embodiment of the user interface to present insight to the business;

FIG. 5 illustrates a tree structure for analyzing gross revenue change;

FIG. 6 illustrates a four quadrant approach employed by a recommendation module for generating recommendations;

FIG. 6 illustrates a four quadrant approach employed by a recommendation module for generating recommendations;

FIG. 7 illustrates a further four quadrant approach employed by a recommendation module for generating recommendations;

FIGS. 8 to 10 illustrate further embodiments of the user interface to present insights and recommendations to the business for a given product category; and

FIG. 11 illustrates a further embodiment of the user interface to present a recommendation to the business.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The advent of online sales, sales and inventory management software (including for brick and mortar entities), online shopping portals, social networks and other disparate sources of digital data has made unprecedented amounts of digital data available to businesses (e.g., including but not limited to corporate entities such as retailers). Frequently, analyzing the digital data for meaningful insight relevant to business performance metrics or indicators is expensive and time-consuming. As the quantity of available digital data expands, the data which is most significant to a business's performance may become obscured by irrelevant data. For example, a retail business looking for factors amongst available digital data correlating to improved sales across a product offering must identify which of the digital data to analyze; however, the digital data available to the retailer may represent hundreds or thousands of factors, including transactions, customers, inventory, store hours and others.

Systems and methods described herein enable businesses to automatically obtain insightful analysis of digital data. The insightful analysis may provide historical insight into a business's operations by analysing the impact of events occurring in the past until the present. The systems and methods automatically determine the most impactful data affecting one or more key performance indicators, without necessarily requiring a user to first query the possibly many potentially relevant (or potentially irrelevant) data items. The systems and methods may further be configured to isolate the impactful data in such a way as to present a user with information that can be leveraged to affect future key performance indicators.

The systems and methods may further be configured to provide recommendations based on the historical insight by recommending hypothetical events to impact the business's performance or operations in view of historical responses.

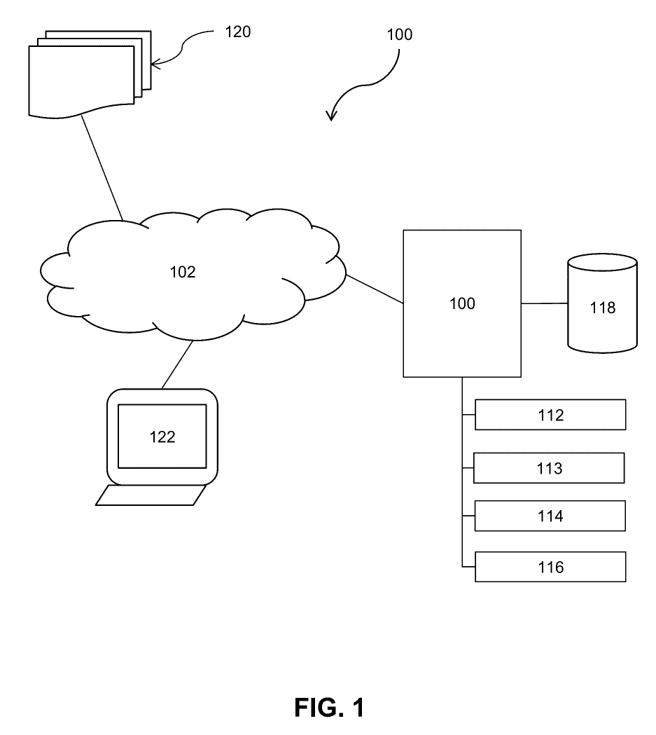

Referring first to FIG. 1, a system (100) comprises a data analysis server (110) linked to a digital data database (118). The data analysis server is linked by a network (102), such as the Internet, to a plurality of digital data sources (120), each of which is embodied as a network accessible server.

Challenges exist for unveiling statistically relevant information associated with particular businesses' performance in the context of a combined online and offline world as there are many disparate sources of data relevant to a suitable analysis, and the handling of and providing context for such data is non-intuitive. Digital data items concerning a business may be generated by the business and by various third party sources. This digital data may be cleansed and structured before being used by the system. Further, the cleansed and structured data may or may not be stored in the same data store as raw data. Collectively, digital data sources capture interactions by the business with third parties, as well as interactions between third parties. Interactions may occur online and in the physical world. As an example, and without limiting the scope of the present disclosure, online interactions could be online purchases made through ecommerce sellers, and “real world” interactions could include retail experiences including purchases made through retailers at bricks-and-mortar locations, including the business's locations. Other online interactions can include social network interactions, email and other messaging interactions, app download histories, app interaction, web interaction, tracking and parsing of content delivered to and between the third parties, etc. Thus, the digital data sources could include social networks, email systems, retail systems, mobile device application providers, and other third parties which generate useable digital data. Mobile device applications may comprise, for example, retail ecommerce applications, an illustrative example of which is an app providing a catalogue and/or means to make purchases from an electronics retailer. Mobile data may comprise geolocation data, for example.

The digital data sources may further comprise the business's proprietary systems, such as, for example, inventory management systems, customer relationship management (CRM) systems, e-commerce systems, accounting or bookkeeping and other systems which generate digital data items typically available exclusively to the business. A business' offline data may be retrieved from Point of Sale (“POS”) systems, in store wifi, in-store cameras, and in-store beacons. In practice, businesses and third parties are constantly generating (or causing to be generated) an abundance of digital data by their activities in the real and online worlds, including by simply moving around, interacting with personal computing devices, making physical and online purchases, etc. Third party digital data sources may be data aggregators who capture and consolidate digital data that is then offered to the business. Data aggregators may capture online and physical world interactions by a plurality of individuals by, for example, mining digital data items that is associated with the individuals, such as the individuals' emails, browsing histories, geolocation histories, etc. Frequently, data aggregators generate and obtain digital data items from computing devices (such as smartphones, tablets, or computers) operated by the plurality of individuals. Data aggregators can also be embodied by loyalty programs which generally obtain data through intermediary physical and online retailers.

Digital data items may further comprise data from external sources, such as, for example, Twitter™ posts, blog posts, the Google Trends™ API, Amazon™, Yahoo! Finance™ for market data, internet of things sensors (which may provide primary digital data for predictive analysis), weather data and other environmental data, data on industry competitors, holiday data, disaster data, news events, and external search trends. Data relating to a business' competitor may also be accessible, including data regarding products and services offered by competitors, and pricing of competitors' goods and services.

Without limiting the scope of the present disclosure, exemplary types of digital data items available to a business include: prices of the business's goods and services, including wholesale prices, retail prices and discounted prices; average prices of goods and services which a given consumer views or purchases from the business; total price of goods and services in a consumer's basket when transacting with the business; variety of goods and services offered by the business, including sub varieties, such as colour and size; availability of goods and services when a consumer is requesting specific goods and services from the business; keywords contained in Internet searches leading customers to the business's website; customer reviews of the business's products and services; transaction speed between a customer and the business; time spent by a consumer on the business's website; number of page views by the consumer while visiting the business's website; number of visits by a customer to the business's premises or website; promotion management systems data; live promotion data from the business' website and campaigns; customer behavior and shopping profiles, including customer shopping and browsing patterns, social media likes, credit card purchases and patterns; referring source bringing a customer to the business's website, referring sources including digital marketing campaigns.

The data analysis server comprises or is linked to an import module (112) which accesses and collects bulk amounts of digital data items from the disparate digital data sources. The collection of digital data items is generally accomplished through the use of scripts incorporating APIs that conform to a defined standard established by each of the sources and/or by “scraping” the digital data with or without the cooperation of the sources. Further, a mobile API may be provided for ingestion of app event data from mobile applications running on mobile devices. The format of this digital data is likely to come in many structured and unstructured formats such as JSON, pure TEXT, images with text (which may require optical character recognition), images (which may require image recognition), speech, and device usage statistics. The import module is operable to process each such format using any suitable techniques. Schema may be used for collecting digital data items. For example, offline Point of Sale (“POS”) digital data collection may be mapped to schema configured for POS.

Generally, the digital data sources accessible to the data analysis server will correspond to digital data sources for which an API or other mechanism exists for obtaining the digital data items and which an operator of the data analysis server has implemented. These digital data sources may, for example, comprise a plurality of loyalty programs, banking applications, mobile device applications, online retailers, offline retailers, social networks, user provided digital data items and mobile digital data items. Various digital data sources and approaches, in this respect, would be known to a person of skill in the art. Further, the import module implement marketing campaign execution tools for ingesting digital data items relating to marketing campaigns, enabling for example, retrieval of digital data items relating to Bronto™ email, ExactTarget™, Google Adwords™, Facebook™ marketing, Twitter™ campaigns, retargeting, Baudi™, Sohu™, and other sources of digital data. The import module may further import digital data items relating to economic indicators in order to identify economic factors potentially affecting the performance of a business or one of its units, such as macroeconomic data including, the Dow Jones Industrial Average, the S&P 500, Financial Times Stock Exchange indexes, gross domestic product, gross national product, unemployment data, consumer price index (“CPI”), employment rate, and income levels in a region.

The data analysis server further comprises or is linked to an insight module (114) which analyzes the digital data items collected by the import module for insights relevant to the business's performance.

The data analysis server further comprises or is linked to a recommendation module (113) which analyzes the digital data items collected by the import module and the insights generated by the insight module for generating recommendations which may be relevant to the insights.

The data analysis server further comprises or is linked to a portal (116) providing a user interface accessible via the network by a client device (122) operated by the business or its agents. The user interface may be accessible as a web frontend, a web app or a client-loaded app interface, and enables the business to interact with the data analysis server. The user interface enables the business to select one or more key performance indicators (KPIs) against which the data analysis server will analyze the digital data items for generating insights or recommendations. The user interface presents generated insights and recommendations, preferably in an easily understood format, such as, for example, graphically, or using plain language text, as described herein in further detail. The user interface may further enable the user to specify to the data analysis server specific ones of the digital data sources from which to import or exclude digital data items for analysis.

KPIs for a business may comprise any financial or other metrics tracked by the business and whose outcomes the business may wish to optimise, such as, for example, income, expenditures, revenues, revenue per customer, volume of sales, customer retention, employee retention, conversion and other KPIs as would be understood by a person of skill in the art. KPIs may represent performance of an entire business, of a division of the business, or of a particular product or service offered by the business.

In use, the business accesses the portal of the data analysis server through the user interface, which is displayed on, and accessible from, a computing device operated by the business or an agent of the business. Upon the business selecting one or more KPIs to analyze, as well as, optionally, specific digital data sources to include or exclude from the analysis, the user interface causes the data analysis server to analyze digital data items for insights and optionally recommendations relevant to the one or more selected KPIs. Alternatively, instead of requiring the business to select KPIs at this time, the business could have preconfigured the data analysis server at a prior time to deliver insights and recommendations relevant to one or more KPIs. The import module imports the digital data items from the various digital data sources according to the business's selection of digital data sources to include or exclude. The data analysis server may store the imported digital data items in the database for subsequent retrieval and analysis. The insight module and recommendation module then obtains the digital data items from the import module and/or the database and undertakes analysis of the digital data items to generate insights and recommendations relevant to the selected KPIs. The portal reports the insights to the business for viewing on the user interface.

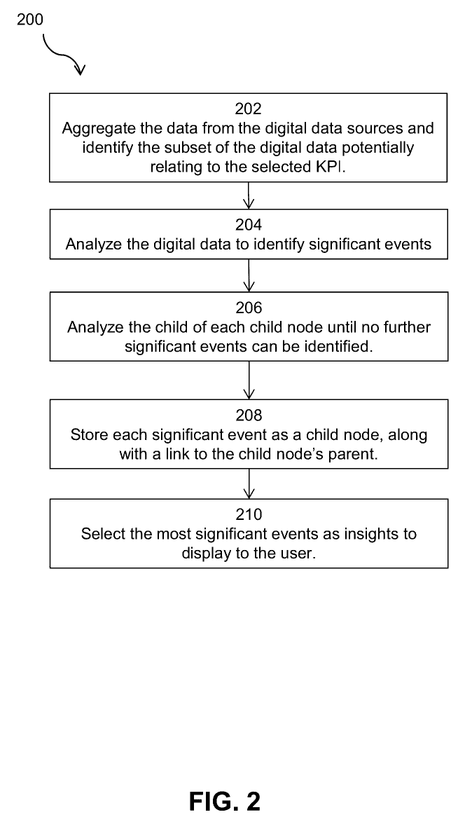

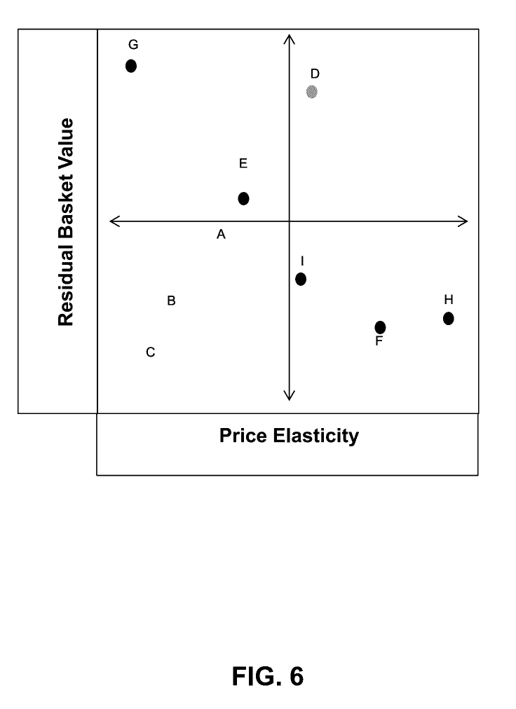

The generation of insights by the insight module (112) will now be described with reference to FIGS. 2 to 5. Subsequently, the generation of recommendations will be described with reference to FIGS. 6 to 11.

Referring now to FIG. 2, a method 200 is shown for generating insights into a business's performance by analyzing digital data items available to the business. Prior to analysing the imported data to generate insights relevant to the selected KPIs, the insight module identifies which of the imported data potentially relates to the selected KPIs, at block 202. In order to assess the relevance of data to a particular KPI, correlations between each KPI and various data sources may be computed in real time, or preferably may be pre-computed and stored. Data sources correlated to a given selected KPI may be included for analysis of that KPI. In order for the data to be imported by the system, it may be structured according to a common format upon ingestion, so that data from disparate sources can be analyzed by the insight module.

To identify relevance of data to a KPI, the insight module may aggregate all potentially related data and then, at block 204, identifies significant events (i.e., significant changes over time between data points) in the digital data items which correlate to changes in the KPIs in order to generate insights. In order to generate the insights for the digital data items, the insight module may invoke a best-fit statistical analysis to model impacts on the outcomes of the KPIs. However, basic statistical models, while often capable of detecting inflection points in KPIs, are frequently insufficient for deconstructing which events in the digital data items are most responsible for effecting the changes in the KPIs. Therefore, the insight module preferably implements a tree-graph analysis technique to analyse the digital data items. In one embodiment, the insight module is configured to analyse the digital data items by first considering one of a plurality of seed nodes. The insight module may be preconfigured to analyse a specific set of seed nodes for any selected KPI, or it may be configured to dynamically identify seed nodes relevant to analysis for any selected KPI without being specifically instructed which seed nodes to choose. The seed nodes may embody high-level performance metrics for the business, such as, for example, changes to income.

At block 206, the insight module then recursively performs analysis on the child, grand-child and further child nodes of the seed node until no further child nodes, or significant child nodes, result from the analysis. A seed node may be skipped if it has already been included in previous seed analysis.

The identification of a child node may comprise comparing changes to factors represented by the digital data items over various time-frames and determining whether any event is statistically significant. Identification of nodes may include analyzing possible metrics for use as seed nodes, and employing an analysis technique such as clustering or a machine learning approach to determine which nodes are major contributors to the change of a KPI; once a major contributor is identified, a “dynamic” analysis is spawned. Further, the insight engine may try possible variables upon which to segment a parent node into a variety of child nodes, picking a segmentation that maximizes a goal identified by the firm, such as, for example, evenly distributing a change evidenced at the parent node. For example, segmentation of a website traffic node may comprise segmenting digital data in order to determine five child variables that contribute as closely as possible to the overall amount of traffic (i.e. preferably such that each of the five nodes contributes 20% of the traffic). Segmentation may be used to divide data into distinct groups so that different actions can be applied to each (e.g. marketing towards different types of customers). In this case, segmentation may be most useful when it is able to divide the data into more or less even groups that are distinct from each other along one or more dimensions. Machine learning techniques can be used to optimize this separation of groups of, for example users, so that it segments them along the most relevant dimensions to get an even distribution. This is contrasted with picking a fixed set of variables to segment on, which may or may not provide an even distribution.

The insight engine may be configured to automatically define a tree structure for the selected KPI, or it may be configured to apply a predefined tree structure for the selected KPI in which the component elements of the KPI are defined. Examples of preconfigured child nodes for a KPI selected as “revenue” in the context of e-commerce may include average order value (“AOV”), conversion rate (“CR”) and number of sessions (i.e., the number of visits to the business or its website); in turn, “AOV” may be further segmented into top products, top brands, top categories, top baskets (frequently purchased items) and changes in top lists; “CR” may be segmented according to a funnel type analysis into nodes indicating where users drop off, as described herein in more detail; and “number of sessions” may be segmented into top landing pages and top referrers/campaigns.

The insight module continues to deconstruct events within the tree structure by analyzing subsets of each node until a node is identified which represents a “within threshold” event, meaning that the event is statistically insignificant. The insight module further assigns weighting to the nodes according to the level of impact of each event represented by the node on the selected KPI. The analysis of digital data items for each set of nodes is a two-step procedure in which the first step comprises identifying unusual or anomalous events in the digital data items and in which the second step comprises conducting deeper analysis on the digital data items associated with the event identified as anomalous. The deeper analysis may comprise identifying in the anomalous event digital sub-data associated with the event, or it may comprise performing a different type of analysis on the event identified as anomalous. Where the tree structure of nodes is preconfigured, analysis may comprise identifying which nodes for a preconfigured set of nodes comprise anomalous data, and conducting deeper analysis on the child nodes of those nodes. Analysis techniques for digital data items at a given node may vary depending on the type of node (if nodes are preconfigured), or for types of digital data, as described in more detail below.

At block 208, the insight module stores each of the child nodes in the database, along with a link identifying the parent node of the child node. While analyzing another parent node and its child nodes, the insight module preferably identifies any child nodes shared between the present parent node and a previously analysed parent node; the insight module preferably refrains from re-analyzing the identified shared child node in order to reduce duplication of effort and computing. The insight module may store a link in the database identifying the further parent node of the shared child node. The links stored alongside each child node enable the insight module to glean the relationship between each of the nodes and the tree comprising all analyzed nodes. The significant events at each level of analysis constitute insights and can be displayed to the user at block 210. For example, if analysis shows that two of four seed nodes comprise anomalous data, insights relating to those anomalous seed nodes can be published for viewing by the requesting business.

Illustrative examples of analysis by the insight module for generating insights will now be described.

In a first example scenario illustrative of the method shown in FIG. 2, a business may request from the data analysis server insights pertinent to maximizing revenue. Revenue is thus the selected KPI in this example. The selection by the business is made in the user interface on a computing device operated by the business or its agent. Upon receiving the query through the portal, the data analysis server causes the import module to import digital data items available for the business to analyze. As previously described, the user may further specify digital data sources to include or exclude from the analysis. The insight module then aggregates all the imported digital data items which may be related to the business's revenue. Business revenue is a higher-level performance indicator for the business, so the insight module may be preconfigured to treat revenue as a seed node in the analysis. The insight module may then segment revenue into periods of activity, such as in this illustrative example, 30-day and 7-day rolling averages, and then compares each 7-day rolling average in the digital data against the 30-day rolling average. The described periods are illustrative, different periods for segmentation are contemplated; further, periods for segmentation could be configured by or for users, or groups of users. For example, 7-day compared against a quarterly average, 7-day compared against a full year average, or the like. In other cases, the segmentation may be customized and chosen by the user. In an example, the insight module can then determine whether any 7-day rolling average deviates from the 30-day rolling average by a threshold amount, such as, for example, 5%. Thus, the insight module may treat any deviation exceeding 5% as a significant event. In another type of analysis, the insight module may instead calculate the standard deviation across a series of 7-day rolling averages, and consider each 7-day rolling average which deviates by greater than a threshold standard deviation as a significant event. The insight module assigns a node to each of the significant events, along with a link to its parent node. In further cases, the threshold deviation can be dynamic and intelligently chosen, using machine learning techniques, by the insight module to learn what is best for the business such that the business can find the most relevant posts or insights. In further cases, the threshold deviation can be chosen or amended by the user.

The insight module may then begin conducting a deeper analysis on the most significantly deviant 7-day rolling average. The insight module segments the 7-day rolling average into three channels: online revenue due to organic search (i.e., natural language search from a search bar or browser); online revenue due to customers arriving from paid email campaigns; and online revenue due to customers arriving from direct-to-customer email blasts. The insight module analyzes each channel by comparing that channel's 30-day rolling average against the rolling average for the same 7-day period as identified in the previous stage. The insight module first determines whether each channel displays a difference above a threshold amount between the 7-day and 30-day rolling averages, and then ranks the above-threshold events from most to least significant. The insight module continues, as before, to further segment and analyze the above-threshold events in order of rank, until no more significant events are identified in the child data.

In still another approach to the above example, instead of using a threshold amount for each node to determine whether to continue with a child analysis of any event, the insight module may instead continue child analyses for a group of nodes on a level of the tree by identifying the most significant nodes which together contribute a threshold amount to the parent node. For example, if, in the same example, the insight module determines that the organic search, email campaign and email blast streams contributed 60%, 30%, and 10% respectively to the change in the seven-day rolling average for the analyzed period, it may continue to analyze only the organic search and email campaign channels, as their combined contribute exceeds a threshold of, for example, 65%. If, however, the threshold were 95%, then the insight module would analyze child events for all three channels.

The implementation by the insight module of tree-graph analysis methods has been found by the applicant to solve technical problems related to computer analysis of business data by enabling a contextual, multi-level, and easily understood analysis. For example, the hierarchical structure of a tree-graph analysis connects diverse sets of sub-analyses so that each sub-analysis may be viewed and understood within the context of other factors. That context may enable businesses to determine the impacts which any changes to child nodes might have on KPIs. Further, the hierarchical structure of the tree-graph analysis may frequently align with the hierarchy within any given business. For example, the CEO of a business may be concerned with a higher level of abstraction than a manager of a store whose performance is significantly related to a selected KPI. The tree-structure analysis method may also enable automated storytelling through the portal, as described herein in greater detail.

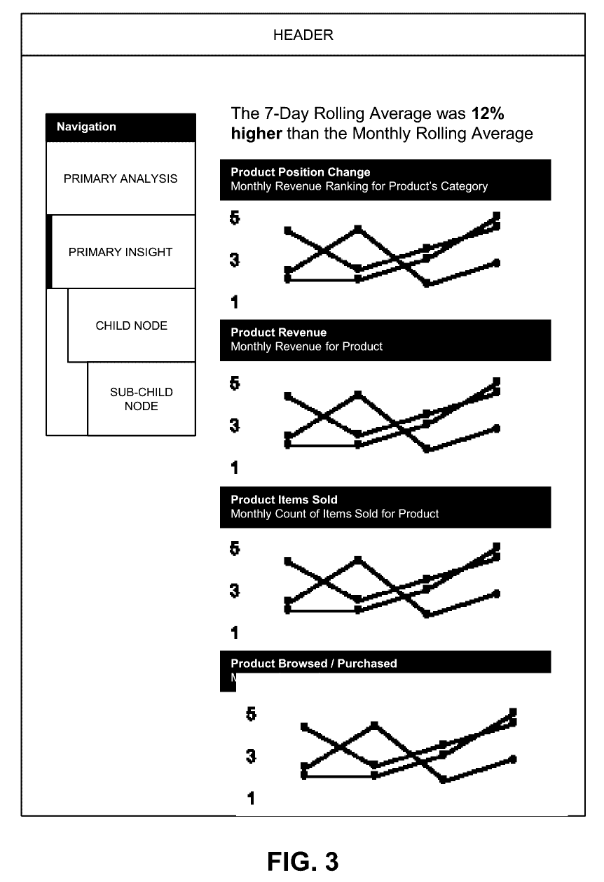

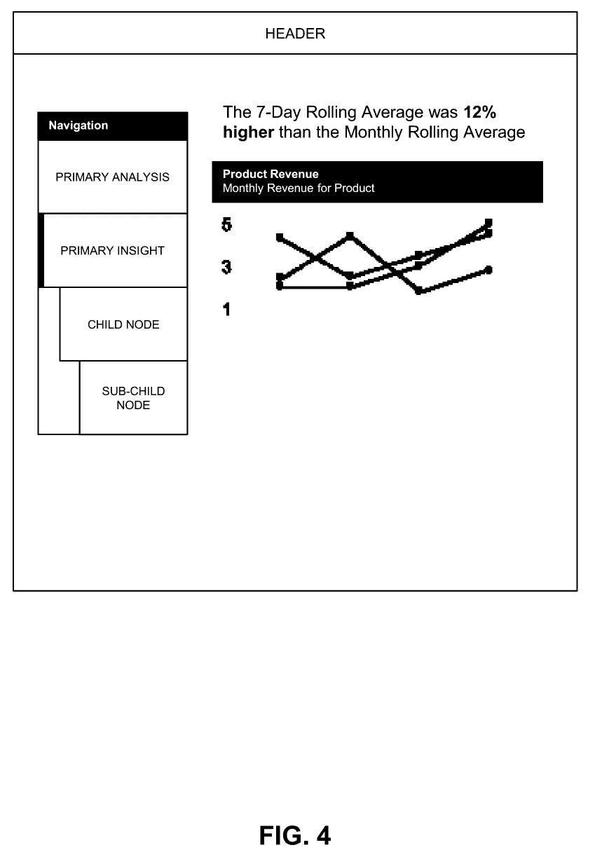

In use, a business interacts with the data analysis server through the portal via a user interface on a computing device operated by the business. The insights are generated to provide to the business a list of factors which most contribute to the selected set of KPIs, and may further identify and present for suggestion changes which the business could implement to optimize the selected KPIs. Because the significant events are mapped as nodes in a tree by storing each significant event alongside one or more links to each parent node for the event, the insight module is able to automatically present contextual insight to the business through the portal. The data analysis server may automatically generate the reporting shown on the user interface, as shown in the interfaces of FIGS. 3 and 4, which is made available to the business via the portal.

Referring now to FIG. 3, an embodiment of the user interface is shown in which the results of an analysis for a selected KPI (in this case, “Revenue”) are presented to illustrate insights for a significant one of the previously described 7-day rolling averages. The database may store a plurality of preconfigured templates, such as, for example, interfaces, phrases, graphs, which the insight module may populate based on the tree-structure analysis to visually or otherwise inform the requesting business of the identified insights. A text box displays Primary Insight, which may represent the most significant nodes in the tree analysis. As shown in Table 3, below, which illustrates an example analysis carried out by the insight module, the most significant contributions to the 7-day rolling average are identified as an increase in the conversion rate, as well as an increase in revenue from customers encountering the business through direct, organic search, and email blast campaigns (BMM). The Deep Analysis text field displays drill down information comprising the most significant child node events of the “direct” channel. The user interface further displays, in graphical format, the historical trend lines for the most significant data, which is identified as products 3 and 4 in this embodiment. The plain-language text with which the user interface is populated, as well as the templates for the graphs and layout for the user interface, may be stored in the database and populated from the tree analysis, as previously described.

Tables 1 to 4 below illustrate example analyses carried out by the insight engine on exemplary digital data. Table 1 illustrates determining if a KPI (e.g. revenue) is above a certain threshold using rolling averages. Table 2 illustrates an exemplary analysis to determine if a deviation in a KPI (in this case, revenue) is sufficiently anomalous to warrant an insight analysis. Table 3 illustrates an exemplary analysis to determine which nodes contribute most significantly towards a change in a KPI in order to select nodes for deeper analysis. Table 4 illustrates an exemplary analysis to determine which nodes are most significant to a given KPI.

TABLE 1
a = 7 day rolling average revenue = 1100 b = 28 day rolling average
revenue = 1000
c = % change = 100 * (a − b) / b = 100 * (1100 − 1000) / 1000 = 10%
t = threshold = 5%
10% > 5%, therefore the threshold is exceeded.

TABLE 2
A = 7 day rolling average revenue for the past 7 days = [100, 200, 300,
200, 100, 200, 500]
m_A = mean (average) of A = 228.57
s_A = standard deviation of A = 138.01
smul_A = multiple of standard deviation for most recent point = |A[7]−
m_A| / s_A = |500 − 228.57| / 138.01 = 1.97
t = threshold = 1.5
1.97 > 1.5, therefore the threshold is exceeded.

TABLE 3
a = 7 day rolling average revenue = 1100
b = 28 day rolling average revenue = 1000
d = absolute change in revenue = 100
Revenue can be broken down into three channels: organic search, paid ads, email, direct.
Their respective breakdowns for revenue for 7/28 days is:
a_direct = 7 day rolling average revenue = 360
b_direct = 28 day rolling average revenue = 400
d_direct = change in revenue = −40
e_direct = abs percent of overall change (d) = 100 * |d_direct| / d = 100 * 40 / 100 = 40%
a_org = 7 day rolling average revenue = 310
b_org = 28 day rolling average revenue = 300
d_org = change in revenue = 10
e_org = abs percent of overall change (d) = 100 * |d_org| / d = 100 * 10 / 100 = 10%
a_paid = 7 day rolling average revenue = 270
b_paid = 28 day rolling average revenue = 200
d_paid = change in revenue = 70
e_paid = abs percent of overall change (d) = 100 * |d_paid| / d = 100 * 70 / 100 = 70%
a_email = 7 day rolling average revenue = 160
b_email = 28 day rolling average revenue = 100
d_email = change in revenue = 60
e_email = abs percent of overall change (d) = 100 * |d_email| / d = 100 * 60 / 100 = 60%
Sorting the segments by e: paid, email, direct and organic search. We keep picking segments in
this order until the sums of the “d” values are above a certain threshold.
t = threshold = 0.80
d_paid = 70
d_paid + d_email = 130 > 0.8 * 100 = 80
This could then result in further analysis of those segments resulting in values above the threshold
(i.e. paid ads and email)

TABLE 4
For revenue the breakdown may be as follows:
revenue = average order value (AOV) * conversion rate (CR) * sessions
Where:
conversions = # of orders
AOV = revenue / conversions
CR = conversions / sessions
These metrics can be reviewed for the past 7 days:
a_rev = 7 day rolling average revenue = 100
a_conversions = 10
a_sessions = 210
a_aov = 100 / 10 = 10
a_cr = 10 / 210 = 4.76%
And also for a “baseline” period, such as 28 days:
b_rev = 28 day rolling average revenue = 125
b_conversions = 11
b_sessions = 200
b_aov = 100 / 10 = 11.36
b_cr = 10 / 200 = 5.5%
A percentage change can be retrieved for the component parts:
c_rev = 100 * (a_aov − b_aov) / b_aov = (100 − 125) / 125 = −20%
c_aov = 100 * (a_aov − b_aov) / b_aov = (10 − 11.36) / 11.36 = −11.97%
c_sessions = 100 * (a_sessions − b_sessions) / b_sessions = (210 − 200) / 200 = 5%
c_cr = 100 * (a_cr − b_cr) / b_cr = (5 − 5.5) / 5.5 = −9%
These component changes can be sorted by their magnitude (ignoring): 11.97 (aov), 9 (cr), 5
(sessions). The changes of each component can then be incrementally applied until a threshold
percentage of the overall change has been reached.
Where the threshold = 80%:
c_aov: (1 − 0.1197) / −20% = 59.85% (responsible for 45% of change)
c_aov + c_cr: [(1 − 0.1197) * (1 − 0.09) − 1] / −20% = −19.89 / 20% = 99% > 80%
AOV and CR would be selected as the most relevant causes of the −20% change in revenue.

Referring now to FIG. 4, another embodiment of the user interface is shown. The Primary Insight and Deep Analysis fields are analogous to those shown in FIG. 3; however, the graphical representation displays the revenue as a plurality of bars representing daily total revenues, alongside lines representing the 7-day running average and monthly running average revenues. The business may efficiently appreciate from the graph where significant events are likely to have been identified by the insight module.

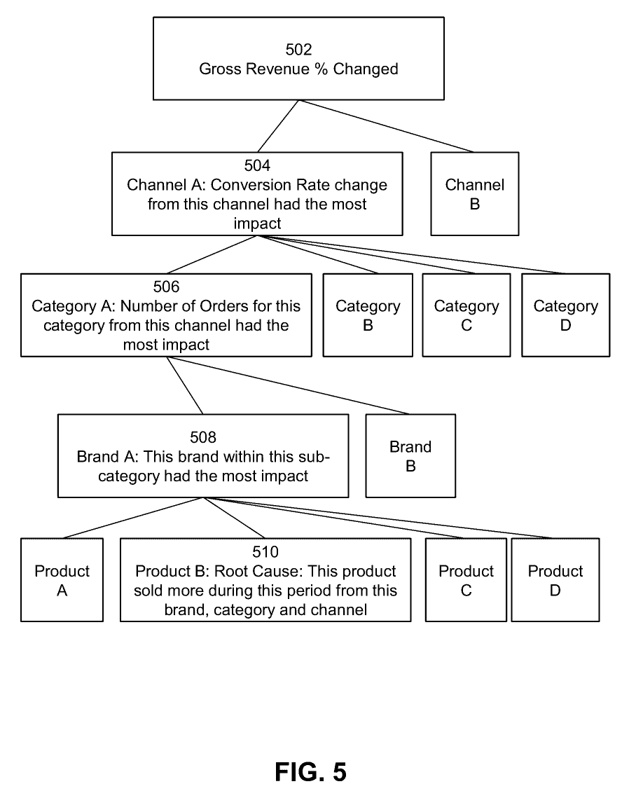

Referring now to FIG. 5, shown therein is an example tree-graph representation of revenue analysis in the e-commerce context. The example tree-graph shows a sequential analysis of child nodes of revenue 502 comprising conversion rate 504, number of orders 506, a particular brand 508 and then a particular product 510, each of which are determined to be most impactful on change at a given level of the illustrated tree-graph structure. At block 502, gross revenue percentage change may be analyzed to determine if a particular period has provided anomalous gross revenue—which may prompt a tree-graph analysis of gross revenue. Component ‘child nodes’ of gross revenue can be analyzed to determine which child node had the most impact, such that the most impactful child nodes can be further analyzed. At block 504, conversion rate is determined to have the most impact on gross revenue percentage change, such that it is further analyzed. At block 506, number of orders is determined to be the component of conversion rate having the most impact on change to conversion rate. At block 508, a particular brand is determined to have the most impact on number of orders. At block 510, a particular product is determined to have had the most impact on the brand, for example, by experiencing higher sales during the relevant period of time. No further child nodes of the product are available for analysis, such that the product is determined to be the root cause of the changes.

Further to the above examples, in addition to analyzing revenue, the number of site visitors could be analyzed. Analyzing visitors may include analyzing groups of users. For example, site visitors may be segmented into different predefined groups, and then the proportion of users in each of the groups can be tracked, as well as changes to each of the groups. Groups might include visitors that had bought from the side more than 10 times in the last year, 5-10 times, and less than 5 times. The groups could further be broken down by determining commonalities among users who changed between groups, such as analyzing categories of purchases, brands of purchases.

It will be appreciated that the above described embodiments provide various features for analysis of intrinsic and extrinsic data by users, the functionality of which is accessible via a user interface provided by the data analysis server through a network-accessible portal. As described above, a noteworthy event can be presented as a story to users—coupled with preconfigured text (as shown in FIGS. 3 to 4), and can be tracked over time; a user may be able to indicate important stories through the user interface, such that those stories will be prioritized for display. Outputs may be used to automatically generate flyers, email, PPC, Retargeting, social media input and onsite promotion zones. Further, some of the digital data consumed by the portal may be output to a digital data marketplace.

A further example of analysis by the insight module will now be briefly described, illustrating particularly how different analysis techniques may be applied at different nodes. As described above, analysis techniques at a given node may vary depending on the type of node (if nodes are preconfigured), or for types of digital data items, as described in more detail below. As described above, analysis of revenue in the ecommerce context can start by looking at the gross revenue for the overall business as a seed node. This first step of the analysis may identify deviations between the weekly rolling average revenue from a baseline of monthly rolling average revenue. If revenue for a week has deviated significantly from revenue for the month, then this may be identified as anomalous. In turn, revenue may be broken down into three key components: conversion rate (“CR”), traffic and average order value (“AOV”). By analyzing the change in these three KPIs, the main driver of revenue change may be determined and other insights may be reported back to a user. The revenue may be segmented further by revenue channels, and the top contributing channels for revenue may be returned as child nodes to be further analyzed. For example, “organic search” and “direct” channels may be child nodes selected for further revenue analysis. The “organic search” may be analyzed similarly to gross revenue. The segmentation done at this level may be by referrer, and may spawn child nodes for analysis, such as, for example, particular search engine websites, including “google.com” and “yahoo.com”, as the top contributors to organic search revenue change. At this level, conversion rate may be the primary driver of the change in revenue. Further child nodes of conversion rate may be analyzed to determine, in detail, the drivers for the change in conversion rate. Analysis of the further child nodes may comprise, for example, a “Conversion Funnel Analysis” to determine where customer retention broke down. A conversion funnel is a sequence of steps that a user must pass through in order to “convert” or purchase a product. This analysis may identify friction points in the buying process in order to increase the likelihood that site visitors end up making purchases. During the analysis one of the steps in the conversion funnel, for example, “check out”, may be identified as the main driver of the increased conversion rate. This insight may be reported to the business, for which it may be a surprise to learn the impact of switching payment processors. Funnel Analysis may more particularly comprise analyzing the aggregate visitor page flow (how the visitor traverses a business's website), creating “funnels” (or preset paths that most users follow), computing the percent of users who flow from step-to-step in each part of the funnel, and identifying significant events at that step which may affect the overall CR. For those steps identified as significant, further analysis may segment the step into, for example, individual webpages that affected the CR. In addition to analyzing “organic search”, the “direct” channel of revenue may then be analyzed. In this case, the increase in revenue may be due to an increase in AOV, such that a Product Basket Analysis may be performed on the “direct” segment. Product basket analysis may show that the composition of baskets has changed in the past week relative to the past month. The change may indicate what drove the increase in AOV. For example, an increase in product baskets including a “gift set” type of item might indicate that the change has been caused by an offering of the “gift set”. This insight may be reported to the business to confirm that its promotion of holiday gift sets has been effective.

Analysis of a broad range of internal and external digital data sources may facilitate deep, insightful analysis. For example, weather, price, promotions and/or discounts can be determined to cause change to KPIs. Further, Google Search Trends, Twitter and Google News events may be monitored. Search demand may be monitored over time by tracking external ad-words and internal search results as demand indicators for drop offs. Further, searches may be monitored to determine influence of particular internal keywords, product description words, and external paid keywords. For example, if revenue dropped for a paid search campaign, the external keywords and/or product keywords that caused the change can be analyzed to determine outside influences. Tracking can compare and contrast different parts of a product life cycle, such as when it is new, mature and/or aging. Customer focus analysis can be performed by analyzing CRM and platform data sources, monitoring Recency Frequency Monetary Value (“RFM”) shifts of customers, and segmenting customers into particular groups. Customer groups can be segmented based on geography, demographics and income from censuses, by device and operating system, and by behaviour (e.g. browsed price vs. purchase price, traffic patterns. The insight module may further supplement digital data which is intrinsic to the business with extrinsic digital data. For example, the insight module may obtain weather data from a suitable digital data source to identify whether a spike in sales in umbrellas is due to weather patterns or a promotion put on by the business.

The above described functionality of the insight module, generally relates to generating insights from digital data items, which may be provided to users and shown on a user interface. The generation of recommendations by the recommendation module (113) will now be described with reference to FIGS. 6 to 11.

In addition to generating insights at the insight engine, a recommendation module may be invoked in order to generate recommendations from the digital data, which may relate to the insights generated by the insight module. An insight may relate to the outcome of a root cause analysis of a change to a KPI; an associated recommendation may relate to a recommended course of action to effect a change to the KPI (such as optimization). Accordingly, insights may lead to the automatic generation of recommendations for a business.

For illustration, in the e-commerce context, recommendations may include recommendations for providing personalized offers, mass promotional campaigns, targeted promotions, etc. to effect change in particular KPIs. Recommendations may comprise: sales event planning by forecasting demand due to more aggressive price discrimination; category management by optimizing stock-outs of product categories; and optimal product substitutions to increase retention. Recommendations may identify what products to promote, when and where to promote them, to whom, and at what price. Recommendations may further comprise: identifying customer segments which would likely respond to advertising, promotions and customer retention efforts.

The recommendation module may generate recommendations based on historical data and insights by analyzing how hypothetical events might impact the business's performance or operations in view of historical responses. The recommendation module may be configured to generate recommendations according to an objective (such as a optimizing a KPI) which may be selected by the user. According to an illustrative embodiment, a user could indicate a desire to maximize sales in a particular product category, while minimizing advertising spending for that category. The insight engine may collect all the possible digital data items relevant to the objective (e.g., factors that impact sales of the product category). The user could then select relevant groups of customers for whom the objective should be optimized (e.g., converting and non-converting populations). A list of factors could be identified that provide the most impact relating to the objective (e.g., a particular consumer sentiment index and price might have the highest weighted effect for a particular product category). The engine may also identify controllable features (business levers) that can be changed by the business to maximize the desired output. The value of the controllable factor(s) may then be optimized in the model in order to optimize an output for the particular objective (e.g., optimal price for each product to maximize sale of the product category category). A best fit model could be employed to predict the outcome on the objective of changes to the features based on analysis techniques, such as utilizing an evolutionary algorithm. The optimization analysis may further rely on machine learning and neural network analysis. Broadly, the optimization comprises a mapping of inputs to outputs, such as, for example, according to the function y=f(x). Based on an objective y, and driven by a function for the objective, the features x can be determined. Techniques employed in generating recommendations may include predictive modeling, price sensitivity analysis, basket analysis, root cause analysis, and analysis of external factors. The recommendation module may model each customer or customer type by using a regression analysis. The recommendation module may predict missing digital data for each customer based on like customers, and forecast demand in face of different target customers or business approaches.

In some embodiments, a ‘four quadrant approach’ may be employed by the recommendation module in order to generate a recommendation by analyzing correlated changes in data. Illustrative techniques for generating recommendations in the e-commerce context based on the four quadrant approach will now be briefly described.

Referring now to FIG. 6, subsequent to an insight relating to a decrease in sales, the recommendation module may analyze historical data in order to provide a recommendation relating to the insight. Historical promotional data may be analyzed, including historical price-sensitivity data relating to past promotions. The recommendation module may analyze how sensitive each historical promotion of a product was to price changes by comparing residual basket size (i.e. shopping cart basket size minus the product on promotion) to price elasticity (i.e. changes to quantity sold correlated to price). If, for example, the promotion is highly sensitive to price changes, and has low residual basket size (i.e. it only sells itself), then the quantity sold data can further be compared to competitor data. A recommendation might be issued that, given the product's historical responsiveness to different promotions, the business should ensure the product's pricing beats the competition when on promotion and that personalized offers should be provided when not on promotion in order to remain competitive. Many products have a cyclical schedule to promotions based on regulations in a country requiring a minimum time on regular price. Analysis of competitor data and other factors can help determine the right timing and value of promotions and make associated recommendations.

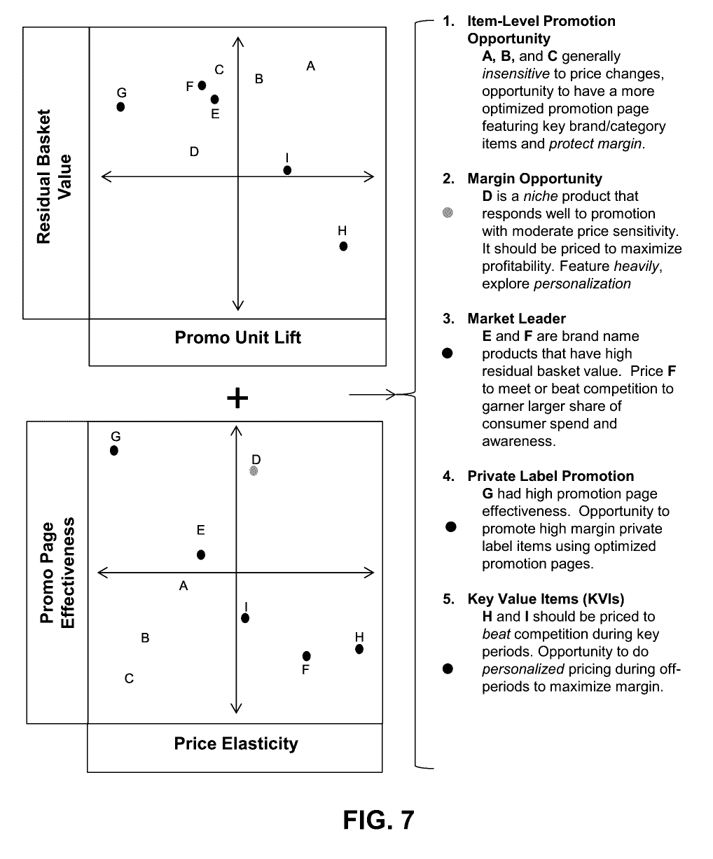

For clarity, FIG. 7 shows analysis of historical data for various products according to a four quadrant approach in order to generate recommendations by the recommendation module. In a first instance, residual basket value can be compared against increase to unit sales of a product being promoted. In a second instance, promotional page effectiveness (i.e. percentage of sales passing through the promotional page) can be compared against a product's price elasticity. The graphs of FIG. 7 show where each of products A to H of a business falls within the two comparisons. Depending on where each product (or group of products) falls with the graphs, a different recommendation (shown as 1 to 5) may be generated. The recommendations may be preconfigured, depending on where a product falls within the possible ‘four quadrants’ of data for a given comparative analysis.

Various factors may be considered and compared according to the four quadrant approach. More specifically, Promo Page Effectiveness as illustrated, relates to the percentage of total sales passing through the promotional page, and measures how effective the promotional page of historical promotions was at driving revenue to the associated products being promoted. The price elasticity looks at the impact on unit movement as a function of product price changes and competitor's price changes, which provides a measure of how sensitive a product or set of products is to price fluctuation. Residual basket value shows the percentage of a transaction provided by items excluding the item being promoted, which provides a measure of how often a product is bought along with other items in order to show cross/up-sell value. Promo Unit Lift shows the unit lift vs. baseline, indicating how many incremental units were sold. Recommendations may be based upon further available factors, including supplier costs, margin, and pricing.

In the example of FIG. 7, the location of products A, B, and C mean they are generally insensitive to price changes, and there is an opportunity to have a more optimized promotion page featuring key brand/category items and protect margin. The location of product D means it is a niche product that responds well to promotion with moderate price sensitivity; it should be priced to maximize profitability and should be featured heavily, explore personalization. The location of products E and F mean they are brand name products that have high residual basket value. F should be priced to meet or beat competition to garner larger share of consumer spend and awareness. The location of product G means it had high promotion page effectiveness and there is an opportunity to promote high margin private label items using optimized promotion pages. The location of products H and I means they should be priced to beat competition during key periods and there is an opportunity to do personalized pricing during off-periods to maximize margin.

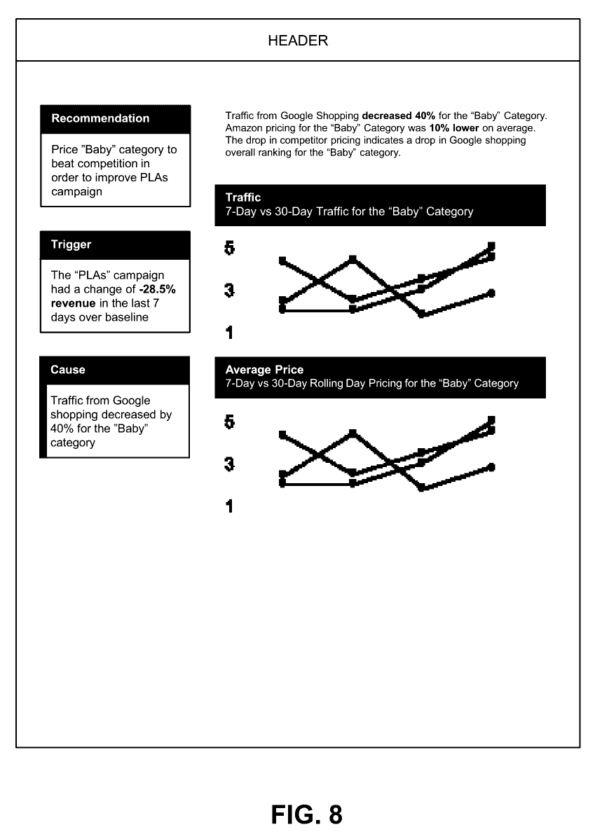

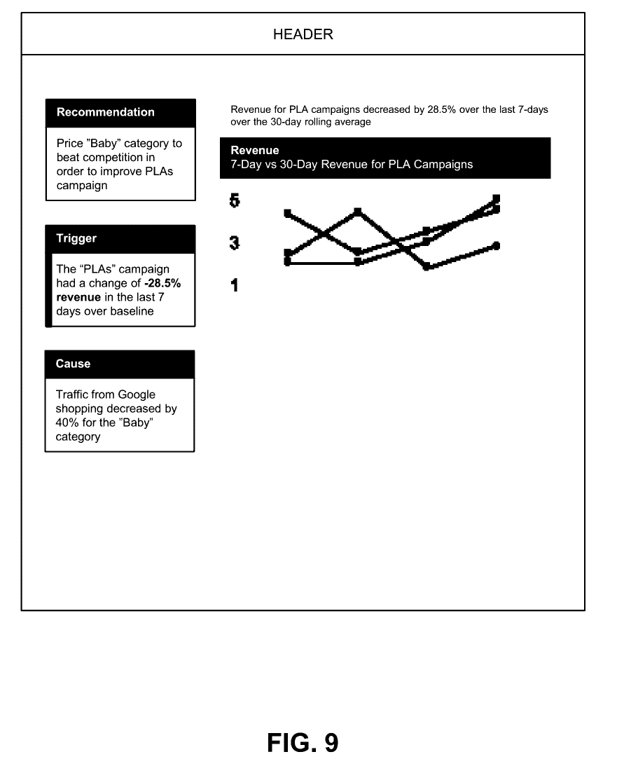

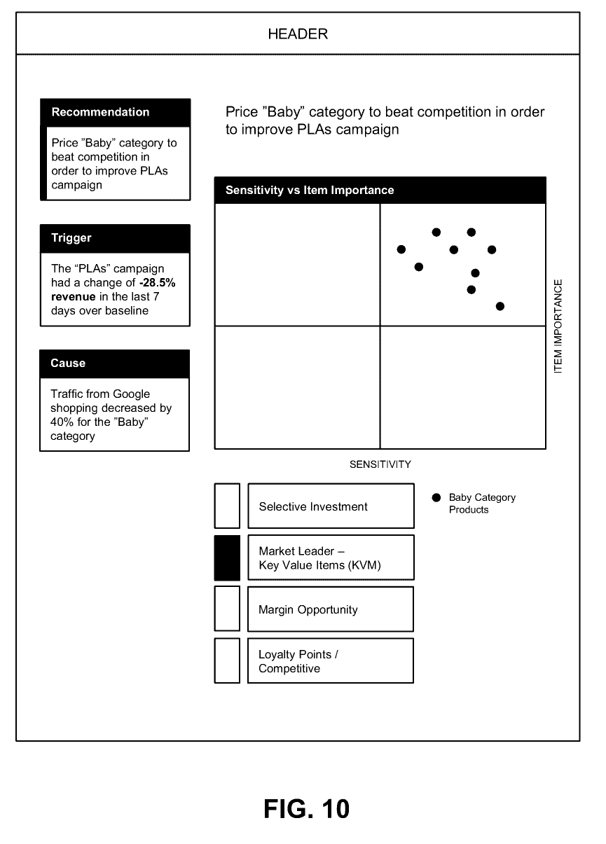

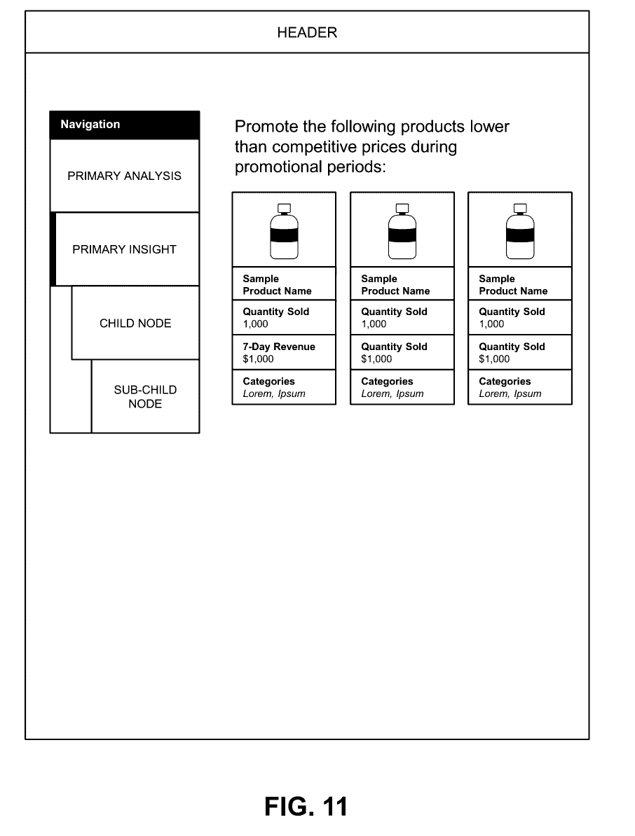

Once insights and recommendations are generated, the insights and recommendations, and the associated data, can be shown to users in a user interface. Referring now to FIGS. 8 to 11, shown therein are further user interface screens. FIG. 8 shows a decrease in a traffic KPI. FIG. 9 shows the results of a root cause analysis of the KPI by the insight module, providing an insight regarding the cause of the change to the KPI. FIG. 10 shows a recommendation generated by the recommendation module for effecting a change to the KPI, as well as the comparison data used in the four quadrant approach. The specific recommendation relates to a recommended pricing for a specific category of products. Referring now to FIG. 11, shown therein is a further user interface screen showing a recommendation. In FIG. 11, revenue associated with a brand of products has decreased, the cause of which was identified by the insight module to be a change to competitor pricing for the brand of products. A recommendation is shown indicating that a specific set of products should be priced competitively to increase revenue.

In a particular case, the user interface can include a search feature such that a user can search for specific brands, categories, products, and the like, in order to group and sort insights and recommendations.

Applicant recognized the intended advantages of the above embodiments, for example, can allow users, such as retailers, make faster decisions and smarter adjustments to improve profitability. A particular intended advantage of the above embodiments is determining the connection between product, price, and promotion, and associated changes in KPI(s). In some cases, the above embodiments can allow for automatic analysis and recommendations to be driven by machine learning and be available in a readable format; for example, in a format useable by category or brand managers.

In an example of the intended advantages of the embodiments described herein, a typical problem for conventional systems is to analyze why certain sales go up or down. Due to the variable nature of price changes, systems may often have to guess by using a catch all reason, such as ‘weather’, if they cannot determine a factor for the price changes. In contrast, the above embodiments use analysis to determine, more definitively, what are the likely factors that resulted in a change in a particular KPI; for example, a reduction in revenue due to the product and promotion level.

Although the foregoing has been described with reference to certain specific embodiments, various modifications thereto will be apparent to those skilled in the art without departing from the spirit and scope of the invention as outlined in the appended claims. The entire disclosures of all references recited above are incorporated herein by reference.

1. A system for generating and analyzing a tree-graph representation of a plurality of digital data items for computational analysis of the potential relevance of the digital data items to key performance indicators (KPIs) to unveil each of the digital data items that are statistically relevant to the KPIs, the digital data items originating from at least one digital data source, the system comprising:
a digital data database for storing at least the digital data; and
a data analysis server linked to the digital data database, the data analysis server in communication with the at least one digital data source, the data analysis server comprising one or more processors configured to execute, or direct to be executed:
an import module for receiving the digital data items from the at least one digital data source; and
an insight module for tree-graph analysis of the digital data items received by the import module, the tree-graph analysis comprising:
receiving one or more KPIs;
representing each of the one or more KPIs by a seed node;
recursively identifying child nodes emanating from each of the one or more seed nodes until there are no statistically significant child nodes, and linking each child node to its parent node from which the child node emanates, each of the child nodes representing one of the digital data items;
analyzing each of the child nodes, alone or in combination with one or more other child nodes, to determine an anomalous event, the anomalous event comprising a deviation which is greater than a threshold amount; and
determining the impact of each of the child nodes associated with one of the anomalous events on its associated parent node.

2. The system of claim 1, wherein machine learning techniques are utilized to determine the impact of the anomalous events.

3. The system of claim 1, wherein the child nodes are determined by segmentation of the associated parent node.

4. The system of claim 3, wherein the segmentation is based on periods of activity.

5. The system of claim 3, wherein machine learning techniques are utilized to determine the segmentation.

6. The system of claim 1, wherein analyzing each of the child nodes further comprises not analyzing a particular one of the child nodes if that particular child node is shared with another parent node and has already been analyzed.

7. The system of claim 1, wherein the one or more processors of the data analysis server are further configured to execute, or direct to be executed, a recommendation module for predicting the impact of events on a predetermined objective based on historical digital data and the statistically significant events.

8. The system of claim 8, wherein the recommendation module uses a four quadrant approach to analyze correlated changes in the digital data to optimize an output for the predetermined objective.

9. The system of claim 9, wherein the optimization of the output for the predetermined objective uses machine learning techniques.

10. The system of claim 1 further comprising a portal linked to a user interface on a computing device for receiving the one or more KPIs from a user and communicating the one or more KPIs to the insight module of the data analysis server.

11. The system of claim 1, wherein the threshold amount is dynamic and chosen by the insight module using machine learning techniques.

12. A method for generating and analyzing a tree-graph representation of a plurality of digital data items for computational analysis of the potential relevance of the digital data items to key performance indicators (KPIs) to unveil each of the digital data items that are statistically relevant to the KPIs, the method comprising:
receiving, via an import module executed on one or more processors, the digital data items;
receiving, via the insight module executed on one or more processors, one or more key performance indicators (KPIs);
representing, via the insight module executed on one or more processors, each of the one or more KPIs by a seed node;
identifying, recursively, via the insight module executed on one or more processors, child nodes emanating from each of the one or more seed nodes until there are no statistically significant child nodes, each of the child nodes representing one of the digital data items;
linking, via the insight module executed on one or more processors, each child node to its parent node from which the child node emanates;
analyzing, via the insight module executed on one or more processors, each of the child nodes, alone or in combination with one or more other child nodes, to determine an anomalous event, the anomalous event comprising a deviation which is greater than a threshold amount; and
determining, via the insight module executed on one or more processors, the impact of each of the child nodes associated with one of the anomalous events on its associated parent node.

13. The method of claim 12, wherein machine learning techniques are utilized to determine the impact of the anomalous events.

14. The method of claim 12, wherein clustering techniques are utilized to determine the impact of the anomalous events.

15. The method of claim 12, wherein analyzing each of the child nodes further comprises not analyzing a particular one of the child nodes if that particular child node is shared with another parent node and has already been analyzed.

16. The method of claim 12, further comprising predicting, via a recommendation module executed on one or more processors, the impact of events on a predetermined objective based on historical digital data and the statistically significant events.

17. The method of claim 16, wherein the predicting of the impact of events uses a four quadrant approach to analyze correlated changes in the digital data to optimize an output for the predetermined objective.

18. The method of claim 12, wherein the one or more seed nodes are dynamically identified based on high-level performance metrics of the digital data.

19. The method of claim 12, wherein the threshold amount is dynamic and chosen by the insight module using machine learning techniques.

20. The method of claim 12, wherein the threshold amount is five-percent (5%).
